(19) United States
(12) Patent Application Publication
(10) Pub. No.: US 2011/0184095 A1
(43) Pub. Date: Jul. 28, 2011

(54) LIGHT FAST ENCAPSULATED PIGMENT

(76) Inventors: Howard S. Tom, San Jose, CA (US); Sivapackia Ganapathiappan, Los Altos, CA (US); Doris Pik-Yiu Chun, Sunnyvale, CA (US); Hou T. Ng, Palo Alto, CA (US)

(21) Appl. No.: 12/692,823

(22) Filed: Jan. 25, 2010

(51) Int. Cl. C09D 133/04; B05D 7/00; B01J 13/02; C08K 5/34; C08K 5/3437

(52) U.S. Cl. 524/88; 427/212; 427/213.34; 524/556; 524/577; 524/89

(57) ABSTRACT

A light fast encapsulated pigment includes an inner core region that includes a pigment and an outer shell that includes a polymer comprising a UV absorber non-covalently incorporated therein. The light fast encapsulated pigment finds use in ink compositions.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Inkjet printers are now very common and affordable. They are used in home printing, office printing and commercial printing Inkjet prints are often known for poor durability since relatively low-cost pigments are often used to lower the overall cost of inkjet printing for the ordinary consumer. In general, the light fastness of low-cost pigment is very poor and is unacceptable for high-value photographic quality digital prints. In many instances a printed image fades too quickly on a media after printing. Visible discoloration can be noticed in a few days after printing when the image is left exposed in ambient lighting. Formulating an inkjet ink often involves compromising competing interests so that an ink composition is obtained that exhibits acceptable durability, which includes, for example, water fastness, light fastness, rub resistance and smear fastness.

Agents for improving durability of ink compositions have been used to improve the light fastness of digital prints. These agents are added to the ink and can be jetted with ink jet printers or other printing technologies. One problem with the durability additives is that they are hydrophobic and can be difficult to incorporate into the ink. The additives in small amount also increase the viscosity of the ink so that the printing may not be reliable. Another disadvantage realized with the use of durability additives is the separation between the additives and the pigment particle once an ink is printed on paper. Water-soluble durability additives diffuse into the paper significantly reducing the concentration of the additive close to the pigment particles. To be effective, it is desirable that the durability additives be in close contact with the pigment particle. To solve this problem, increased amounts of the additives are required to obtain the desired improvement in durability. As a result, the cost of the ink product is increased, which is undesirable for low-cost applications. In another approach for enhancing the durability of inks, pigments are modified to make them less sensitive to interaction with light and chemicals. The modifications to the pigment can also increase the cost of pigments. The increase in cost is prohibitive for inks used in printing applications where the cost-per-page is an important factor.

### DETAILED DESCRIPTION

Some embodiments of the present invention are directed to encapsulated pigments, which comprise an inner core region comprising a pigment and an outer shell comprising a polymer comprising a UV absorber non-covalently incorporated therein. In some embodiments the polymer of the outer shell is a latex polymer. In some embodiments the pigment is a low-cost pigment, which may be a cyanine, a phthalocyanine, a naphthalocyanine, an acridone, a quinacridone, or an azo pigment, or a combination of two or more of the above. In some embodiments the encapsulated pigment further comprises one or more of a light stabilizer, antioxidant and free radical scavenger, for example.

Some embodiments of the present invention are directed to an ink composition comprising an ink vehicle and the encapsulated pigment discussed above.

Some embodiments of the present invention are directed to methods of preparing a pigment composition having light fastness properties. A pigment is combined with one or more monomers and a non-monomeric UV absorber. The combination is subjected to conditions for forming a polymer from the one or more monomers. During the polymerization the pigment becomes encapsulated in the polymer and the UV absorber becomes non-covalently incorporated in the polymer. In some embodiments of the above methods, the conditions for forming a polymer are selected from the group consisting of emulsion polymerization conditions, mini-emulsion polymerization conditions, living radical polymerization conditions, redox polymerization conditions, and addition and condensation polymerization conditions.

As mentioned above, encapsulated pigments of the present embodiments comprise an inner core region and an outer shell, which surrounds the inner core region, thus resulting in encapsulation of the pigment. The size of the encapsulated pigment is dependent on a number of factors including, for example, one or more of the size of the inner core or pigment, the thickness of the outer shell, the processing method, rheology and the loading of materials. In some embodiments the size (cross-sectional dimension) of the encapsulated pigment is in a range from about 1 nanometer (nm) to about 1,000 nm, or from about 1 nm to about 750 nm, or from about 1 nm to about 600 nm, or from about 1 nm to about 500 nm, or from about 1 nm to about 400 nm, or from about 1 nm to about 300 nm, or from about 1 nm to about 200 nm, or from about 1 nm to about 100 nm, or from about 1 nm to about 50 nm, or from about 5 nm to about 1,000 nm, or from about 5 nm to about 750 nm, or from about 5 nm to about 500 nm, or from about 5 nm to about 400 nm, or from about 5 nm to about 300 nm, or from about 5 nm to about 200 nm, or from about 5 nm to about 100 nm, or from about 5 nm to about 50 nm, or from about 10 to about 1000 nm, or from about 10 nm to about 500 nm, or from about 10 nm to about 400 nm, or from about 10 nm to about 300 nm, or from about 10 nm to about 200 nm, or from about 10 nm to about 100 nm, or from about 10 nm to about 50 nm.

The inner core region of the encapsulated pigment comprises a pigment. The term “pigment” refers to a single pigment or a mixture of two or more pigments. Thus, the inner core comprises at least one pigment or at least two pigments or at least three pigments, for example. The number of pigments in a mixture of pigments that comprise the inner core region is in the range of 1 to about 5, or 1 to about 4, or 1 to about 3, or 1 to 2, about 2 to about 5, or about 2 to about 4, or about 2 to 3, or about 3 to about 5, or 3 to 4, or 4 to 5.

In many embodiments the pigment is a low-cost pigment, which means that the pigment may be prepared, or otherwise obtained, inexpensively (based on industry standards and needs) and usually has one or more undesirable properties that affect the durability of the pigment. Factors relating to the durability of the pigment include one or more of water fastness, light fastness, highlighter fastness, smear fastness and rub resistance, for example.

The pigment may be inorganic or organic. The pigment may be a naturally-occurring pigment or a synthetic pigment. The pigment can be of any color including, but not limited to, black, blue, brown, cyan, green, white, violet, magenta, red, orange, yellow, as well as spot colors from mixtures thereof. For electro-photographic printing important colors include Cyan (C), Magenta (M), Yellow (Y), and Black (K), which are precisely layered to create thousands of other colors. In some embodiments the pigment is a particulate pigment.

The shape of a particulate pigment may be regular or irregular. A particulate pigment may be in the form of a bead, flake, plate, rod, platelet, cube or column, for example. In some embodiments the cross-sectional shape of the particulate pigment may be circular, triangular, square, quadrangular, hexangular, oval, scalloped, corrugated, or ellipsoidal, for example.

The particle size (cross-sectional dimension) of a particulate pigment is in a range from about 1 nanometer (nm) to about 500 nm, or from about 1 nm to about 400 nm, or from about 1 nm to about 300 nm, or from about 1 nm to about 200 nm, or from about 1 nm to about 100 nm, or from about 1 nm to about 50 nm, or from about 5 nm to about 500 nm, or from about 5 nm to about 400 nm, or from about 5 nm to about 300 nm, or from about 5 nm to about 200 nm, or from about 5 nm to about 100 nm, or from about 5 nm to about 50 nm, or from about 10 nm to about 500 nm, or from about 10 nm to about 400 nm, or from about 10 nm to about 300 nm, or from about 10 nm to about 200 nm, or from about 10 nm to about 100 nm, or from about 10 nm to about 50 nm.

Examples of organic pigments that may be present in the ink composition include, by way of illustration and not limitation, perylenes, phthalocyanine pigments (for example, phthalo green and phthalo blue), cyanine pigments (for example, Cy3, Cy5, and Cy7), naphthalocyanine pigments, nitroso pigments, azo pigments (monoazo pigments, diazo pigments, diazo condensation pigments, for example), basic dye pigments, alkali blue pigments, blue lake pigments, phloxin pigments, quinacridone pigments, lake pigments of acid yellow 1 and 3, isoindolinone pigments, dioxazine pigments, carbazole dioxazine violet pigments, alizarine lake pigments, vat pigments, phthaloxy amine pigments, carmine lake pigments, tetrachloroisoindolinone pigments, perinone pigments, thioindigo pigments, anthraquinone pigments and quinophthalone pigments, and mixtures of two or more of the above and derivatives of the above.

By way of illustration and not limitation, representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red), Pigment Red 216 (Brominated Pyanthrone Red) and Pigment Red 226 (Pyranthrone Red). Representative examples of perylenes include Pigment Red 123 (Vermillion), Pigment Red 149 (Scarlet), Pigment Red 179 (Maroon), Pigment Red 190 (Red), Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128, and Pigment Yellow 138. Other examples of pigments include those of the HOSTAFINE® series (trademark of Clariant GmbH, Frankfurt, Germany), the PALIOGEN® series and the HELIOGEN® series (both trademarks of BASF Aktiengesellschaft, Ludwigshafen, Germany), the SUDAN® series, the HOSTPERM® series and the HEUCO® series (trademark of Heubach GmbH, Langelsheim, Germany), for example.

Inorganic pigments that may be present in the pigment dispersion, include, for example, metal oxides (for example, titanium dioxide, electrically conductive titanium dioxide, iron oxides (e.g., red iron oxide, yellow iron oxide, black iron oxide and transparent iron oxides), aluminum oxides, silicon oxides, and zinc oxides), carbon black pigments (e.g., furnace blacks), metal sulfides, metal chlorides, and mixtures thereof.

The encapsulated pigment also comprises an outer shell comprising a polymer, which encapsulates the pigment. The polymer is generally about 1 to about 10,000 monomer units or more in length, or about 10 to about 10,000 monomer units in length, or about 100 to about 10,000 monomer units in length, or about 500 to about 10,000 monomer units in length, or about 1,000 to about 10,000 monomer units in length, or about 2,000 to about 10,000 monomer units in length, or about 3,000 to about 10,000 monomer units in length, or about 5,000 to about 10,000 monomer units in length, or about 10 to about 8,000 monomer units in length, or about 100 to about 8,000 monomer units in length, or about 1,000 to about 8,000 monomer units in length, or about 100 to about 7,000 monomer units in length, for example. The term “monomer” means a molecule capable of undergoing polymerization to form a polymer. The number of monomer units depends on the number of atoms in the monomer unit chain, and the composition of the monomer unit, for example.

In some embodiments the molecular weight of the polymer is about 300 to about 10,000,000 amu or more, or about 500 to about 10,00,000 amu, or about 1,000 to about 10,000,000 amu, or about 10,000 to about 10,000,000 amu, or about 100,000 to about 10,000,000 amu, or 300 to about 5,000,000 amu or more, or about 500 to about 5,00,000 amu, or about 1,000 to about 5,000,000 amu, or about 10,000 to about 5,000,000 amu, or about 100,000 to about 5,000,000 amu, or 300 to about 1,000,000 amu or more, or about 500 to about 1,00,000 amu, or about 1,000 to about 1,000,000 amu, or about 10,000 to about 1,000,000 amu, or about 100,000 to about 1,000,000 amu, or about 100 to about 750,000 amu, or about 500 to about 750,000 amu, or about 1,000 to about 750,000 amu, or about 10,000 to about 750,000 amu, or about 100,000 to about 750,000 amu, or about 100 to about 500,000 amu, or about 200 to about 500,000 amu, or about 1,000 to about 500,000 amu, or about 10,000 to about 500,000 amu, or about 100,000 to about 500,000 amu, for example. In some embodiments, the monomer units of the polymer comprise carbon atoms and may additionally comprise one or more heteroatoms such as, for example, oxygen, sulfur, nitrogen, phosphorus and silicon.

The polymer may be a linear polymer or a branched polymer or a combination thereof. A linear polymer comprises a linear chain of atoms and a branched polymer comprises a branched chain of atoms. Each atom of the linear chain may have one or more substituents in place of hydrogen. In some embodiments, the polymer may be a copolymer comprising more than one type of monomer unit. The relationship of the different monomer units in the polymer may be alternating, random or periodic, for example, and the polymer may also be in a block copolymer arrangement where blocks of repeating monomer units form the polymer chain.

In some embodiments encapsulated pigments may be prepared from one or more monomers in a number of approaches known in the art. Examples of approaches for preparing polymers, by way of illustration and not limitation, include emulsification or emulsion polymerization, free radical polymerization, redox polymerization, bulk polymerization, transition metal catalyzed coupling, condensation (step reaction) polymerization, living polymerization, living radical polymerization, addition (chain reaction) polymerization (anionic, etc.), coordination polymerization, emulsion polymerization, ring opening polymerization, solution polymerization, step-growth polymerization, plasma polymerization, Ziegler process, radical polymerization, atom transfer radical polymerization, reversible addition fragmentation- chain transfer polymerization, and nitroxide mediated polymerization, for example. Other methods of encapsulating the pigment include, for example, mini-emulsion polymerization, inversion emulsification, inverse-emulsion polymerization, for example. The conditions employed for encapsulation of the pigment depend on the particular polymerization or other method employed, the nature of the monomers, for example.

In some embodiments the polymer encapsulating material is a latex polymer. The latex polymer may be derived from a number of monomers such as, by way of example and not limitation, vinyl monomers, allylic monomers, olefins, and unsaturated hydrocarbons, and mixtures thereof. Classes of vinyl monomers include, but are not limited to, acrylic acid, acrylates, acrylamides, methacrylic acid, methacrylates, methacrylamide, N- and N,N-disubstituted methacrylamides, vinyl aromatic monomers, vinyl halides, vinyl esters of carboxylic acids (e.g., vinyl acetate), and vinyl ethers. The monomers may further be classified as acidic (acrylic acid, methacrylic acid, itaconic acid, maleic acid, vinyl benzoic acids, and styrene sulfonates, for example) and hydrophobic (acrylates, methacrylates, styrene and substituted styrene, for example).

Examples of methacrylates include, but are not limited to, methyl methacrylate, ethyl methacrylate, propyl methacrylate, isopropyl methacrylate, n-butyl methacrylate, iso-butyl methacrylate, tert-butyl methacrylate, hexyl methacrylate, 2-ethylhexyl methacrylate, lauryl methacrylate, octadecyl methacrylate, isobornyl methacrylate, cyclohexyl methacrylate, benzyl methacrylate, 3,3,5-trimethylcyclohexyl methacrylate, isocane methacrylate, glycidyl methacrylate, 3,4-epoxycyclohexylmethyl-methacrylate, 2-(3,4-epoxycyclohexyl)ethyl-methacrylate, hydroxyethyl methacrylate, hydroxypropyl methacrylate, hydroxybutyl methacrylate, methacrylic anhydride, diethyleneglycol bismethacrylate, 4,4′-isopropylidenediphenol bismethacrylate (Bisphenol A dimethacrylate), alkoxylated 4,4′-isopropylidenediphenol bismethacrylate, trimethylolpropane trismethacrylate and alkoxylated trimethylolpropane trismethacrylate.

Examples of vinyl aromatic monomers that may be used include, but are not limited to, styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, but are not limited to, vinyl chloride and vinylidene fluoride. Vinyl esters of carboxylic acids that may be used include, but are not limited to, vinyl acetate, vinyl butyrate, vinyl methacrylate, vinyl 3,4-dimethoxybenzoate, vinyl malate and vinyl benzoate. Examples of vinyl ethers that may be employed include, but are not limited to, butyl vinyl ether and propyl vinyl ether, for example.

In some embodiments a mixture of one or more hydrophobic monomers and one or more acid monomers may be employed. The number of different monomers employed may be, for example, 1 to about 10, or about 1 to about 9, or about 1 to about 8, or about 1 to about 7, or about 1 to about 6, or about 1 to about 5, or about 1 to about 4, or about 1 to about 3, or 1 to 2, or 2 to about 10, or about 2 to about 9, or about 2 to about 8, or about 2 to about 7, or about 2 to about 6, or about 2 to about 5, or about 2 to about 4, or 2 to 3, or 3 to about 10, or about 3 to about 9, or about 3 to about 8, or about 3 to about 7, or about 3 to about 6, or about 3 to about 5, or 3 to 4.

One or both of the amount of each type of monomer in the mixture and the amount of each hydrophobic monomer or each acid monomer is dependent on the desired character of the encapsulated pigment, for example. In some embodiments the number, type and amount of monomers are chosen to adjust the glass transition temperature (T_{g}) of the polymer. In some embodiments the T_{g} of the polymer is about −100 to about +150° C., or about −50 to about +150° C., or about −40 to about +150° C., or about −40 to about +120° C., or about −40 to about +100° C., or about −40 to about +80° C., or 0 to about +150° C., or 0 to about +120° C., or 0 to about +100° C., or 0 to about +75° C., or 0 to about +50° C., or −25 to about +100° C., or about −25 to about +75° C., or about −25 to about +50° C., or −25 to about +25° C., for example.

In some embodiments a crosslinking monomer can be used in the preparation of the encapsulated pigment. The crosslinking monomer is a compound having two or more of unsaturated hydrocarbon groups of at least one kind selected from the group consisting of a vinyl group, an allyl group, an acryloyl group, a methacryloyl group, a propenyl group, a vinylidene group and a vinylene group. Examples thereof include ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxyneopentyl glycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)-phenyl] propane, 2,2-bis[4-(acryloxyethoxy-diethoxy)phenyl]propane, 2,2-bis[4-(acryloxyethoxypolyethoxy)phenyl]propane, hydroxypivaric acid neopentyl glycol diacrylate, 1,4-butanediol diacrylate, dicyclopentanyl diacrylate, dipentaerythritol hexaacrylate, dipentaerythritol monohydroxypentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol di-methacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxypropane, 2,2-bis[4-(methacryloxy)phenyl]propane, 2,2-bis[4-(methacryloxyethoxy)phenyl]propane, 2,2-bis[4-(methacryloxythioxydiethoxy)phenyl]propane, 2,2-bis[4-(methacryloxy-ethoxypolyethoxy)phenyl]propane, tetrabromobisphenol A dimethacrylate, dicyclopentanyl dimethacrylate, dipentaerythritol hexamethacrylate, glycerol dimethacrylate, hydroxypivaric acid neopentyl glycol dimethacrylate, dipentaerythritol monohydroxypentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl) isocyanurate, allyl methacrylate, divinylbenzene, diallyl phthalate, diallyl terephthalate, diallyl isophthalate and diethylene glycol bisallylcarbonate.

The size of the encapsulated pigment formed is dependent on one or more of the concentration of the reagents, the size of the inner core or a particulate pigment, and the size of the polymer outer shell, for example. The particle size (cross-sectional dimension) of the encapsulated pigment is in a range from about 1 nanometer (nm) to about 1,000 nm, or from about 1 nm to about 750 nm, or from about 1 nm to about 500 nm, or from about 1 nm to about 400 nm, or from about 1 nm to about 300 nm, or from about 1 nm to about 200 nm, or from about 1 nm to about 100 nm, or from about 1 nm to about 50 nm, or 2 nm to about 500 nm, or from about 2 nm to about 400 nm, or from about 2 nm to about 300 nm, or from about 2 nm to about 200 nm, or from about 2 nm to about 100 nm, or from about 2 nm to about 50 nm, or from about 5 nm to about 500 nm, or from about 5 nm to about 400 nm, or from about 5 nm to about 300 nm, or from about 5 nm to about 200 nm, or from about 5 nm to about 100 nm, or from about 5 nm to about 50 nm, or from about 10 nm to about 500 nm, or from about 10 nm to about 400 nm, or from about 10 nm to about 300 nm, or from about 10 nm to about 200 nm, or from about 10 nm to about 100 nm, or from about 10 nm to about 50 nm.

In the encapsulated pigments of the present embodiments, an outer shell comprises a polymer comprising a UV absorber non-covalently incorporated therein. The term “non-covalently incorporated” means that the UV absorber is present in, or associated with, the polymer matrix but is not covalently bound to the polymer, that is, the UV absorber is not attached to the polymer by a chemical bond either directly or through the intermediacy of a linking group such as by incorporation into the polymer as a monomeric unit during polymerization.

The UV absorber is any substance that one or both absorbs UV light and enhances the light fastness of the polymer-encapsulated pigment. The UV absorber is also referred to herein as a “light fastness additive.” In some embodiments the UV absorber contains a UV blocking chromophore, which imparts light fastness to the polymer-encapsulated pigment. The UV absorbers may be water-based or oil-based. The UV absorber is not capable of being polymerized as part of the polymer outer shell of the encapsulated pigment. In some embodiments the UV absorber is not a monomer. Examples of UV absorbers that may be employed in the present embodiments include, by way of illustration and not limitation, benzophenones such as, for example, CHIMASSORB® 81 Ciba Corporation (Suffolk, Va.); benzotriazoles such as, for example, TINUVIN® 1130, TINUVIN® 171, TINUVIN® 384, TINUVIN® 928, and CIBAFAST® H LIQUID (all from Ciba); triazines such as, for example, TINUVIN® 400, TINUVIN® 405, TINUVIN® 479 and TINUVIN® 477 (all from Ciba); TINUVIN® 109, TINUVIN® 384-2, TINUVIN® 2140, TINUVIN® 5050, and TINUVIN® 5151 (all from Ciba); other UV absorbers from Ciba including, for example, TINUVIN® 328, TINUVIN® 384, TINUVIN® 900, TINUVIN® 928, TINUVIN® 1130, TINUVIN® 123, TINUVIN® 144, TINUVIN® 292, TINUVIN® 1405, TINUVIN® 1930; UV absorbers available from Sunko Ink Co., Ltd, including, for example, UV-1®, UV-2® and UV-4®; UV absorbers available from Adeka Argus Chemical Co. including, for example, LA-77® and LA-62®; UV absorbers available from Johuku Chemical Co. including, for example, JF-77®.

The amount of the UV absorber in the polymer is dependent on one or more factors such as, for example, the nature of the pigment, the nature and use of the ink composition comprising the encapsulated pigment and the nature of the UV absorber. In some embodiments the amount (percent by weight) of UV absorber in the polymer outer shell is about 0.01 to about 20%, or about 0.05 to about 20%, or about 0.1 to about 20%, or about 0.5 to about 20%, or about 1 to about 20%, or about 2 to about 20%, or about 5 to about 20%, or about 10 to about 20%, or about 0.01 to about 15%, or about 0.05 to about 15%, or about 0.1 to about 15%, or about 0.5 to about 15%, or about 1 to about 15%, or about 2 to about 15%, or about 5 to about 15%, or about 10 to about 15%, or about 0.01 to about 10%, or about 0.05 to about 10%, or about 0.1 to about 10%, or about 0.5 to about 10%, or about 1 to about 10%, or about 2 to about 10%, or about 5 to about 10%, for example.

The encapsulated pigment may further comprise one or more durability agents such as, for example, a light stabilizer (such as, for example, a hindered amine light stabilizer), an antioxidant, a free radical scavenger, a water resistance material, a humid fastness agent, or mixtures of two or more of the above. Examples of hindered amine light stabilizers, by way of illustration and not limitation, include TINUVIN® 292, TINUVIN® 123, TINUVIN® 144 and TINUVIN® 152 (all from Ciba Corporation). Examples of UV absorber/hindered amine light stabilizer blends, by way of illustration and not limitation, include TINUVIN® 5050, TINUVIN® 5060, and TINUVIN® 5151 (all from Ciba Corporation). Examples of antioxidants, by way of illustration and not limitation, include IRGANOX® 1010, IRGANOX® 1076, IRGANOX® 1330 and IRGANOX® 3114 (all from Ciba Corporation).

The durability agent (other than the UV absorber) may be incorporated either non-covalently or covalently and may be incorporated into the outer shell polymer or into the inner core of the encapsulated pigment. In some embodiments other durability agents may be incorporated non-covalently into the polymer in the same manner as the UV absorber as discussed above. The amount of the additional durability agents in the polymer-encapsulated pigment depends on one or more of the nature of the durability agent, the nature of the pigment, the nature of the ink composition, the nature of the printing process utilizing the ink composition, and whether the durability agent is in the outer shell or the inner core of the polymer-encapsulated pigment, for example. In some embodiments the amount (percent by weight) of one or more durability agents (other than the UV absorber) in the encapsulated pigment is about 0.01 to about 20%, or about 0.05 to about 20%, or about 0.1 to about 20%, or about 0.5 to about 20%, or about 1 to about 20%, or about 2 to about 20%, or about 5 to about 20%, or about 10 to about 20%, or about 0.01 to about 15%, or about 0.05 to about 15%, or about 0.1 to about 15%, or about 0.5 to about 15%, or about 1 to about 15%, or about 2 to about 15%, or about 5 to about 15%, or about 10 to about 15%, or about 0.01 to about 10%, or about 0.05 to about 10%, or about 0.1 to about 10%, or about 0.5 to about 10%, or about 1 to about 10%, or about 2 to about 10%, or about 5 to about 10%, for example.

In some embodiments the encapsulated pigment is prepared, for example, by emulsion polymerization, which produces uniformly sized, nanometer particles of encapsulated pigment. A monomer composition comprising one or more monomers in a suitable liquid medium is subjected to agitation (e.g., using one or more of mixing bar, rocking and shaking) gentle shearing (e.g., using one or both of sonication and milling) or high shearing (e.g., ultrasonication and microfluidization). The amount of the monomer(s) and the conditions for forming the monomer emulsion depend on one or both of the nature of the polymerization and the nature of the monomers, for example. In some embodiments the temperature during the formation of the monomer emulsion is about 10° C. to about 100° C., or about 10° C. to about 50° C., or about 10° C. to about 40° C., or about 20° C. to about 100° C., or about 20° C. to about 50° C., or about 20° C. to about 40° C., for example. The time period is about 0.01 to about 5 hours or more, or about 0.1 to about 5 hours or more, or about 0.2 to about 5 hours or more, or about 0.01 to about 4 hours or more, or about 0.1 to about 4 hours or more, or about 0.2 to about 4 hours or more, or about 1 to about 5 hours, or about 1 to about 4 hours or more, or about 1 to about 3 hours or more, or about 2 to about 5 hours or more, for example. The nature of the liquid medium is dependent on one or more of the nature of the monomers and the nature of the polymerization, for example. The liquid medium may be, for example, an aqueous medium or an organic solvent medium, or a combination thereof

The pigment is combined with a suitable polymerization medium, which, by way of illustration and not limitation, may be an aqueous medium or an organic solvent medium, or a combination thereof. The polymerization medium also contains the UV absorber and may also contain a polymerization initiator, one or more other durability agents and one or more surfactants to control the diameter of the polymer-encapsulated pigment. The monomer composition in the liquid medium described above is combined with the polymerization medium. In some embodiments the monomer composition is added dropwise to the polymerization medium. Other modes of combining the monomer emulsion in the liquid medium with the polymerization medium may also be employed. Depending on the nature of the monomers, the monomers may self-polymerize, polymerize through a condensation reaction, or polymerize through free radical addition polymerization by means of a thermal activated free radical initiator, for example.

The conditions for polymerization include, for example, a temperature of about 5° C. to about 150° C., or about 15° C. to about 125° C., or about 20° C. to about 120° C., or about 20° C. to about 100° C. The temperature may be constant during the polymerization or the temperature may be varied one or more times during the polymerization. The medium is incubated under conditions for forming the encapsulated pigment comprising an inner pigment core and an outer polymer shell with the UV absorber non-covalently incorporated in the outer shell. The incubation period may be about 1 minute to about 20 hours or more, or about 10 minutes to about 20 hours or more, or about 30 minutes to about 20 hours or more, or about 1 hour to about 20 hours or more, or about 1 hour to about 15 hours, or about 1 hour to about 10 hours, or about 1 hour to about 5 hours, for example. The pH of the reaction medium is in the range of about 0.3 to about 10, or about 2 to about 9, or about 5 to about 8, or about 5 to about 7, or about 6 to about 9, or about 7 to about 9, for example. The encapsulated pigment is separated from the reaction mixture by, for example, filtration or centrifugation, and is purified by washing, for example.

In another approach for preparation of a polymer-encapsulated pigment in accordance with the present embodiments, a polymer is prepared from appropriate monomers by any of the aforementioned polymerization techniques. A pigment is added to a molten polymer (temperature of about 40 to about 200° C.) that is sprayed or drop-wise added into a lower temperature liquid bath (temperature of about 0 to about 40° C.) in which the molten solution forms nanospheres and solidifies by freezing. The molten polymer and bath liquid are immiscible. The sprayed particles may optionally be solidified by exposure to a gas or gases (e.g. air or inert gas). Alternatively, a pigment may be combined with a solid polymer in a suitable solvent. The pigment and polymer are selected to be immiscible in a liquid bath, while the solvent is selected to be miscible in both the pigment-polymer combination and the bath solution. The pigment-polymer combination is added dropwise to the agitated bath to form nanospheres. The solvent is drawn into the bath liquid sufficient to solidify the pigment-polymer spheres.

In one embodiment an encapsulated pigment has an inner core comprising an aluminum oxide pigment. The outer shell of the encapsulated pigment is a polymer that comprises polymerized methyl methacrylate and methacrylic acid monomers (1:1 by weight). A benzophenone UV absorber (CHIMASSORB® 81 from Ciba Corporation) (2%) is non-covalently distributed in the polymer outer shell. The cross-sectional diameter of the polymer-encapsulated pigment is about 200 nm. An ink composition is prepared, which comprises the encapsulated pigment in an aqueous medium and further comprises one or more of a surfactant, a humectant, a sequestering agent, and a biocide, for example, as set forth below. The ink is used in an inkjet printer and is dispensed to the surface of paper. The printed paper is evaluated for light fastness using a fadeometer such as, for example, ATLAS Model 25/18 FTRM Fadeometer (Atlas Inc.). The print on the paper exhibits a light fastness improvement of about 10% over that obtained in the absence of the UV absorber.

In one embodiment an encapsulated pigment has an inner core comprising a cynanine pigment (Cy7). The outer shell of the encapsulated pigment is a polymer that comprises polymerized styrene and vinyl benzoic acid monomers (2:1 by weight). A benzotriazole UV absorber (TINUVIN® 1130 from Ciba Corporation) (4%) is non-covalently distributed in the polymer outer shell. Also, in the polymer are TINUVIN® 123 (Ciba Corporation) (as a free radical scavenger) (2%) and IRGANOX® 1010 (Ciba Corporation) (as an antioxidant) (2%) The cross-sectional diameter of the encapsulated pigment is about 225 nm. An ink composition is prepared, which comprises the encapsulated pigment in an aqueous medium and further comprises one or more of a co-solvent, a dispersant, a surfactant and a biocide, as set forth below. The ink is used in an inkjet printer and is dispensed to the surface of paper. The printed paper is evaluated for light fastness using an ATLAS Fadeometer. The print on the paper exhibits a light fastness improvement of about 30% over that obtained in the absence of the UV absorber.

In one embodiment an encapsulated pigment has an inner core comprising a combination of Pigment Red 122 and Pigment Yellow 74 pigments. The outer shell of the encapsulated pigment is a polymer that comprises polymerized n-hexyl methacrylate monomer and methacrylic acid monomer (1:1 by weight). A triazine UV absorber (TINUVIN® 81 from Ciba Corporation) (4%) is non-covalently distributed in the polymer outer shell. The cross-sectional diameter of the polymer-encapsulated pigment is about 250 nm. An ink composition is prepared, which comprises the polymer-encapsulated pigment in an aqueous medium and further comprising one or more of a co-solvent, a dispersant, a surfactant and a biocide, as set forth below. The ink is used in an inkjet printer and is dispensed to the surface of paper. The printed paper is evaluated for light fastness using an ATLAS Fadeometer. The print on the paper exhibits a light fastness improvement of about 30% over that obtained in the absence of the UV absorber.

In one embodiment an encapsulated pigment has an inner core comprising Pigment Yellow 128 pigment. The outer shell of the encapsulated pigment is a polymer that comprises polymerized methyl methacrylate monomer, hexyl acrylate monomer, mono-methacryloyloxyethyl succinate monomer and ethylene glycol dimethacrylate monomer. The ratio of monomers to one another (by weight) is 120/25/2.5/1. A triazine UV absorber (TINUVIN® 479 from Ciba Corporation) (4%) is non-covalently distributed in the polymer outer shell, which also comprises 3% IRGANOX® 1010 antioxidant (Ciba Corporation) and 4% TINUVIN® 292 hindered amine light stabilizer (Ciba Corporation). The cross-sectional diameter of the polymer-encapsulated pigment is about 250 nm. An ink composition is prepared, which comprises the polymer-encapsulated pigment in an aqueous medium and further comprising one or more of a co-solvent, a dispersant, a surfactant and a biocide, as set forth below. The ink is used in an inkjet printer and is dispensed to the surface of paper. The printed paper is evaluated for light fastness using an ATLAS Fadeometer. The print on the paper exhibits a light fastness improvement of about 40% over that obtained in the absence of the UV absorber.

The encapsulated pigments of the present embodiments are stable in an ink environment, which may be any liquid medium such as, for example, an aqueous medium, an oil-based medium, a polar or non-polar organic medium, or a molten (hot melt) medium. An ink composition comprising an encapsulated pigment in accordance with the present embodiments provides enhanced light fastness properties. The UV absorber that is non-covalently incorporated into the polymer matrix provides an advantage of being in a closer association with the pigment particles than for a UV absorber that is covalently bound to the polymer. In the latter instance, the location of the UV absorber in the polymer matrix is restricted by chemical attachment to the polymer.

In some embodiments, the encapsulated pigments of the present embodiments find use in many different water-based systems such as coatings and inks, for example. The encapsulated pigments of the present embodiments may be used in most ink media known in the art. The ink compositions comprising the present encapsulated pigments provide a variety of colors depending on the nature of the pigment(s) of the encapsulated pigments.

In some embodiments, the encapsulated pigment is employed in an aqueous medium, which is a water-based system that may or may not contain other solvents such as organic solvents. For example, the aqueous medium may contain organic solvents such as alcohols, ethers, esters, amides, glycols, or pyrrolidones, or mixtures of two or more organic solvents. The amount (by weight percent) of the organic solvent may be between about 0.01 and about 20%, or between about 0.01 and about 10% or between about 0.01 and about 5%, or about 0.1 and about 20%, or between about 0.1 and about 10% or between about 0.1 and about 5%, or about 1 and about 20%, or between about 1 and about 10% or between about 1 and about 5%.

The aqueous medium may also optionally include one or more water-soluble surfactants in amounts ranging between about 0 and 5%, or between about 0.1 and about 5%, or about 0.5 and about 5%, or about 1 to about 5%. Examples of suitable surfactants include, by way of illustration and not limitation, fluorosurfactants, alkyl polyethylene oxides, non-ionic surfactants, amphoteric surfactants, ionic surfactants, and mixtures of two or more of the above. The balance of the aqueous medium is usually water. In an embodiment the aqueous medium comprises a mixture of water, glycol and a polymer-encapsulated pigment, for example, for most everyday printing applications.

In other embodiments, the ink composition comprising an encapsulated pigment in accordance with the present embodiments is a solvent-based ink made with volatile organic compounds. Suitable organic solvents include, for example, cyclohexane, methanol, ethanol, ethylene glycol, diethylene glycol, triethylene glycol, polyethylene glycol, propylene glycol, butylene glycol, pentylene glycol, hexylene glycol, and polyhydric alcohols and combinations of two or more of the above. The organic solvent-based inks find use in printing of vinyl substrates (e.g., billboards and banners), plastic substrates (e.g., credit cards) and packaging materials, for example.

The amount of the polymer-encapsulated pigment in the ink medium depends on one or more of the nature of the pigment, the nature of the polymer, the nature of the printing process and the nature of the ink medium, for example. The amount (by weight percent) of the encapsulated pigment in the ink medium may be about 0.5 to about 40%, or about 0.5 to about 30%, or about 0.5 to about 20%, or about 0.5 to about 10%, or about 0.5 to about 5%, or about 1 to about 30%, or about 1 to about 20%, or about 1 to about 15%, or about 1 to about 10%, or about 1 to about 5%, or about 1 to about 3%, or about 2 to about 20%, or about 2 to about 10%, or about 5 to about 20%, or about 5 to about 15%, or about 5 to about 10%, for example.

The ink composition comprising the encapsulated pigment can further comprise an emulsifier in an amount (percent by weight) of about 0.05 to about 30%, or about 1 to about 20%, for example. Suitable emulsifiers include, for example, 2-propanol, di-1,2-propylene glycol, 2-pyrrolidone, N-methyl-2-pyrrolidone, 2,4,7,9-tetramethyl-5-decyne-4,7-diol, and 1,1,1-trimethylolpropane.

The ink composition may also comprise a dispersant in an amount (percent by weight) of about 0.05 to about 30%, or about 1 to about 20%, for example. Dispersants suitable for use in the ink composition include, for example, polyethandiol, polypropandiol, sodium dioctyl sultonsuccinate, an alkylene oxide adduct of acetylene glycol, a polybutyl resin, a cellulose derivative, a styrene/acrylic copolymer, maleic acid/styrene copolymer, or a polymer containing both hydrophilic and hydrophobic segments.

The ink composition can also include a surfactant, which provides emulsification, dispersal, wetting, penetration, dissolution, foaming, defoaming, and detergency properties. Commercially available surfactants include CT-141® from Air Products (Allentown, Pa.), CT-151® from Air Products, OT-75® from Cytec (Woodland Park, N.J.), GPG® from Cytec, and OT-70PG® from Cytec. The amount (percent by weight) of surfactant may be about 0.05 to about 30%, or about 1 to about 20%, for example.

The ink composition can further include a pH buffer solution, which may be, for example, a buffer solution comprising one or more of diethanolamine, triethanolamine, hydroxides of alkali metal such as lithium hydroxide, sodium hydroxide, and potassium hydroxide, ammonium hydroxide, and carbonates of alkali metals such as lithium carbonate, sodium carbonate, and potassium carbonate. The selection of the appropriate buffer solution depends on one or both of the nature of the solvent medium of the ink composition and the nature of the printing technique, for example.

The ink composition can further include a chelating agent in an amount (percent by weight) of about 0.05 to about 30%, or about 1 to about 20%, for example. The chelating agent prevents generation of crystalline salts, thus preventing coagulation of particles and plugging of a nozzle of an ink cartridge. Chelating agents suitable for use include sodium ethylenediaminetetraacetate, trisodium nitrilotriacetate, hydroxyethyl ethylenediamine trisodium acetate, diethylenetriamino pentasodium acetate, and uramil disodium acetate, for example.

The ink composition can further include a biocide or preservative to inhibit the growth of microorganisms. The biocide may be any standard biocide. The amount of biocide is an amount that obtains a biocidal effect.

### Definitions:

The following provides definitions for terms and phrases used above, which were not previously defined.

Percentages are by weight unless indicated otherwise.

The phrase “at least” as used herein means that the number of specified items may be equal to or greater than the number recited. The phrase “about” as used herein means that the number recited may differ by plus or minus 10%; for example, “about 5” means a range of 4.5 to 5.5. The term “between” when used in conjunction with two numbers such as, for example, “between about 2 and about 50” includes both of the numbers recited. Moreover, examples herein are intended to be illustrative only and are presented for discussion purposes and not by way of limitation.

The term “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, and thioaryl.

The term “heteroatom” as used herein means nitrogen, oxygen, phosphorus or sulfur. The term “heterocyclic” means having an alicyclic or aromatic ring structure, which includes one or more heteroatoms.

The term “aromatic” as used herein includes monocyclic rings, bicyclic ring systems, and polycyclic ring systems, in which the monocyclic ring, or at least a portion of the bicyclic ring system or polycyclic ring system, is aromatic (exhibits, e.g., π-conjugation). The monocyclic rings, bicyclic ring systems, and polycyclic ring systems of the aromatic ring systems may include one or both of carbocyclic rings and heterocyclic rings. The term “carbocyclic ring” denotes a ring in which each ring atom is carbon. The term “heterocyclic ring” denotes a ring in which at least one ring atom is not carbon and comprises 1 to 4 heteroatoms.

The term “alkyl” as used herein means a branched, unbranched, or cyclic saturated hydrocarbon group, which typically, although not necessarily, contains from 1 to about 50 carbon atoms, or 1 to about 40 carbon atoms, or 1 to about 30 carbon atoms for example. Alkyls include, but are not limited to, methyl, ethyl, n-propyl, isopropyl, n-butyl, isobutyl, t-butyl, octyl, and decyl, for example, as well as cycloalkyl groups such as cyclopentyl, and cyclohexyl, for example.

As used herein, the term “alkenyl” means a linear, branched or cyclic hydrocarbon group of 2 to about 50 carbon atoms, or 2 to about 40 carbon atoms, or 2 to about 30 carbon atoms or more that further contains at least one double bond, such as ethenyl, n-propenyl, isopropenyl, n-butenyl, isobutenyl, octenyl, decenyl, tetradecenyl, hexadecenyl, eicosenyl, and tetracosenyl, for example.

As used herein, the term “alkynyl” means a linear, branched or cyclic hydrocarbon group of 2 to about 50 carbon atoms, or 2 to about 40 carbon atoms, or 2 to about 30 carbon atoms or more that further contains at least one triple bond, such as ethynyl, n-propynyl, isopropynyl, n-butynyl, isobutynyl, octynyl, decynyl, tetradecynyl, hexadecynyl, eicosynyl, and tetracosynyl, for example.

The term “alkoxy” as used herein means an alkyl group bound to another chemical structure through a single, terminal ether linkage, having 1 to about 50 carbon atoms, or 1 to about 40 carbon atoms, or 1 to about 30 carbon atoms.

The term “alkenoxy” as used herein means an alkenyl group bound to another chemical structure through a single, terminal ether linkage, having 1 to about 50 carbon atoms, or 1 to about 40 carbon atoms, or 1 to about 30 carbon atoms.

The term “alkynoxy” as used herein means an alkynyl group bound to another chemical structure through a single, terminal ether linkage, having 1 to about 50 carbon atoms, or 1 to about 40 carbon atoms, or 1 to about 30 carbon atoms.

The term “thioalkyl” as used herein means an alkyl group bound to another chemical structure through a single, terminal thio (sulfur) linkage, having 1 to about 50 carbon atoms, or 1 to about 40 carbon atoms, or 1 to about 30 carbon atoms.

The term “thioalkenyl” as used herein means an alkenyl group bound to another chemical structure through a single, terminal thio (sulfur) linkage, having 1 to about 50 carbon atoms, or 1 to about 40 carbon atoms, or 1 to about 30 carbon atoms.

The term “thioalkynyl” as used herein means an alkynyl group bound to another chemical structure through a single, terminal thio (sulfur) linkage, having 1 to about 50 carbon atoms, or 1 to about 40 carbon atoms, or 1 to about 30 carbon atoms.

The term “aryl” means a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to about 50 carbon atoms, or 5 to about 40 carbon atoms, or 5 to 30 carbon atoms or more. Aryl groups include, for example, phenyl, naphthyl, anthryl, phenanthryl, biphenyl, diphenylether, diphenylamine, and benzophenone.

The term “aryloxy” as used herein means an aryl group bound to another chemical structure through a single, terminal ether (oxygen) linkage, having from 5 to about 50 carbon atoms, or 5 to about 40 carbon atoms, or 5 to 30 carbon atoms or more. The term “phenoxy” as used herein is aryloxy wherein aryl is phenyl.

The term “thioaryl” as used herein means an aryl group bound to another chemical structure through a single, terminal thio (sulfur) linkage, having from 5 to about 50 carbon atoms, or 5 to about 40 carbon atoms, or 5 to 30 carbon atoms or more. The term “thiophenyl” as used herein is thioaryl wherein aryl is phenyl.

### EXAMPLES

Unless otherwise indicated, materials in the experiments below may be purchased from Aldrich Chemical Company, St. Louis, Mo.

### Example 1

### Pigment Dispersion

Pigment PY74 from Heubach (20 g) was mixed with water (113.3 g) containing sodium dodecylsulfate (4 g). This mixture was stirred at ambient temperature and then was subjected to ultrasonication using a Branson Digital Sonifier Model 450 (Branson Ultrasonics Corporation, Danbury, Conn.) for 1 hour (hr) at 90% amplitude. The mixture was subjected further to microfluidization at 90 psi with three passes to obtain pigment dispersion of about 14.3% solid in water.

### Example 2

### Pigment Encapsulation with Light Fast Additive

The pigment dispersion from Example 1 above (83.5 g) is mixed with an emulsion prepared by mixing lightfast additive TINUVIN® 1130 (1 g), styrene (5.4 g), butyl methacrylate (6 g), methacrylic acid (0.6 g), hexadecane (0.36 g) and azobisisobutyronitrile (0.36 g) in water (8 g) containing sodium dodecylsulfate (0.36 g). The mixture is shaken well and then is subjected to microfluidization at 90 psi with three passes. The mixture is heated to 80° C. for 15 hr to obtain a polymer encapsulated pigment containing lightfast additive (i.e., UV absorber) non-covalently attached to the polymer matrix.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A light fast encapsulated pigment comprising:
(i) an inner core region comprising a pigment and
(ii) an outer shell comprising a polymer comprising a UV absorber non-covalently incorporated therein.

2. The light fast encapsulated pigment according to claim 1, wherein the polymer of the outer shell is a latex polymer.

3. The light fast encapsulated pigment according to claim 2, wherein the latex polymer comprises polymerized hydrophobic monomers, polymerized acid monomers, and polymerized cross-linked monomers, and mixtures thereof.

4. The light fast encapsulated pigment according to claim 2, wherein the latex polymer comprises polymerized monomers selected from the group consisting of acrylates, methacrylates, styrenes, vinyl halides, vinyl esters, and vinyl ethers, and mixtures thereof.

5. The light fast encapsulated pigment according to claim 1, wherein the pigment is selected from the group consisting of cyanines, phthalocyanines, naphthalocyanines, acridones, quinacridones, and azo pigments, and mixtures thereof.

6. The light fast encapsulated pigment according to claim 1, wherein the UV absorber is selected from the group consisting of benzophenones, benzotriazoles, and triazines, and mixtures thereof.

7. The light fast encapsulated pigment according to claim 1, further comprising one or more of a light stabilizer, antioxidant and free radical scavenger incorporated therein.

8. An ink composition comprising an ink vehicle and the light fast encapsulated pigment according to claim 1.

9. An ink composition comprising:
(a) an ink vehicle; and
(b) a light fast encapsulated pigment dispersed in the ink vehicle, the encapsulated pigment comprising (i) an inner core region comprising a pigment and (ii) an outer shell comprising a polymer comprising a UV absorber non-covalently incorporated therein.

10. The ink composition according to claim 9, wherein the UV absorber is selected from the group consisting of benzophenones, benzotriazoles, and triazines, and mixtures thereof.

11. The ink composition according to claim 9, wherein the polymer further comprises one or more of a light stabilizer, antioxidant, and free radical scavenger incorporated therein.

12. The ink composition according to claim 9, wherein the polymer of the outer shell is a latex polymer.

13. The ink composition according to claim 9, wherein the pigment is selected from the group consisting of cyanines, phthalocyanines, naphthalocyanines, acridones, quinacridones, and azo pigments, and mixtures thereof.

14. The ink composition according to claim 9, wherein the ink vehicle is an aqueous solvent.

15. A method of preparing a pigment composition having light fastness properties, the method comprising:
(a) combining a pigment with one or more monomers and a non-monomeric UV absorber; and
(b) subjecting the combination to conditions for forming a polymer from the one or more monomers wherein the pigment becomes encapsulated in the polymer and wherein the UV absorber becomes non-covalently incorporated in the polymer.

16. The method according to claim 15, wherein the UV absorber is selected from the group consisting of benzophenones, benzotriazoles, and triazines, and mixtures thereof.

17. The method according to claim 15, wherein the polymer further comprises one or more of a light stabilizer, antioxidant, and free radical scavenger incorporated therein.

18. The method according to claim 15, wherein the polymer of the outer shell is a latex polymer.

19. The method according to claim 15, wherein the pigment is selected from the group consisting of cyanines, phthalocyanines, naphthalocyanines, acridones, quinacridones, and azo pigments, and mixtures thereof.

20. The method according to claim 15, wherein the conditions for forming a polymer are selected from the group consisting of emulsion polymerization conditions, living radical polymerization conditions, and redox polymerization conditions.
